(19) United States
(12) Patent Application Publication
(10) Pub. No.: US 2018/0156980 A1
(43) Pub. Date: Jun. 7, 2018

(54) FIBER OPTICAL COUPLER

(71) Applicant: INDUSTRIAL TECHNOLOGY RESEARCH INSTITUTE, Hsinchu (TW)

(72) Inventor: Tzu-Yi LIAO, Taoyuan City (TW)

(73) Assignee: INDUSTRIAL TECHNOLOGY RESEARCH INSTITUTE, Hsinchu (TW)

(21) Appl. No.: 15/673,388

(22) Filed: Aug. 9, 2017

(30) Foreign Application Priority Data
Dec. 2, 2016 (TW) 105140003

(51) Int. Cl. G02B 6/32; G02B 6/38

(52) U.S. Cl. CPC G02B 6/32; G02B 6/3894; G02B 6/3874

(57) ABSTRACT

A fiber optical coupler, configured to couple two optical fibers, includes a base and a lens. The base has an accommodation chamber and two light passing openings. The light passing openings are respectively connected to two opposite sides of the accommodation chamber. The lens is disposed in the accommodation chamber and located between the light passing openings. The optical fibers are configured to be respectively disposed on two opposite sides of the lens and respectively aligned with the light passing openings. Each of the two optical fibers has a core sharing an optical axis of the lens. When a numerical aperture is NA, an axial distance between the optical fiber and the lens is D, an effective radius of the lens is H, a focal length of the lens is f, half of a maximum angle of cone is θ, the following conditions are satisfied: θ=sin⁻¹(NA); and D=2f=H/(2*tan θ).

### CROSS-REFERENCE TO RELATED APPLICATIONS

This non-provisional application claims priority under 35 U.S.C. § 119(a) on Patent Application No(s). 105140003 filed in Taiwan, R.O.C. on Dec. 2, 2016, the entire contents of which are hereby incorporated by reference.

### TECHNICAL FIELD

The disclosure relates to a fiber optical coupler.

### BACKGROUND

A fiber optical coupler is a passive optical device for optical communication. The fiber optical coupler is used to align end faces of two optical fibers with each other, thus the optical signal emitted from one of the optical fibers is coupled into the other optical fiber. For the high power coupling optical fibers, the coupling efficiency is decreased if the end faces of the optical fibers are not well-aligned. In such a case, during the optical communication, the energy of light emitted from the optical fiber is easily converted into heat due to coarse end faces or dust on the end faces, resulting in burning on the cores of the optical fibers near the end faces. Thus, the improvement of coupling efficiency is a crucial topic in the design of the fiber optical coupler.

### SUMMARY

One embodiment of the disclosure provides a fiber optical coupler configured to couple two optical fibers. The fiber optical coupler includes a base and a lens. The base has an accommodation chamber and two light passing openings. The two light passing openings are respectively connected to two sides of the accommodation chamber opposite to each other. The lens is disposed in the accommodation chamber and located between the two light passing openings. The two optical fibers are configured to be respectively disposed on two sides of the lens opposite to each other and respectively aligned with the two light passing openings. Each of the two optical fibers has a core sharing an optical axis of the lens. When a numerical aperture of each of the two optical fibers is NA, an axial distance between a light emitting end of each of the optical fibers and an optical center of the lens is D, an effective radius of the lens is H, a focal length of the lens is f, half of a maximum angle of a cone of light, that entering or exiting the lens, located between one of the optical fibers and the lens is θ, and the following conditions are satisfied:

θ=sin⁻¹(NA); and

D=2f=H/(2*tan θ).

Another embodiment of the disclosure provides a fiber optical coupler configured to couple two optical fibers. The fiber optical coupler includes a casing and a lens. The casing has an accommodation chamber and two light passing openings. The two light passing openings are respectively connected to two sides of the accommodation chamber opposite to each other. The lens is disposed in the accommodation chamber and located between the two light passing openings. The two optical fibers are configured to be respectively disposed on two sides of the lens opposite to each other and respectively aligned with the two light passing openings. Each of the two optical fibers has a core sharing an optical axis of the lens. When a numerical aperture of each of the two optical fibers is NA, an axial distance between a light emitting end of each of the optical fibers and an optical center of the lens is D, an effective radius of the lens is H, a focal length of the lens is f, half of a maximum angle of a cone of light, that entering or exiting the lens, located between one of the optical fibers and the lens is θ, and the following conditions are satisfied:

θ=sin⁻¹(NA); and

D=2f=H/(2*tan θ).

### BRIEF DESCRIPTION OF THE DRAWINGS

The present disclosure will become better understood from the detailed description given hereinbelow and the accompanying drawings which are given by way of illustration only and thus are not intending to limit the present disclosure and wherein:

FIG. 1A is a cross sectional view of a fiber optical coupler according to a first embodiment;

FIG. 1B is an exploded view of the fiber optical coupler in FIG. 1A;

FIG. 1C is a schematic view of two optical fibers coupled by the fiber optical coupler in FIG. 1A;

FIG. 2 is a cross sectional view of a fiber optical coupler according to a second embodiment;

FIG. 3A is an exploded view of a fiber optical coupler according to a third embodiment;

FIG. 3B is a cross sectional view of the fiber optical coupler in FIG. 3A;

FIG. 4 is a cross sectional view of a fiber optical coupler according to a fourth embodiment while two optical fibers are coupled thereon;

FIG. 5 is a cross sectional view of a fiber optical coupler according to a fifth embodiment; and

FIG. 6 is a cross sectional view of a fiber optical coupler according to a sixth embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

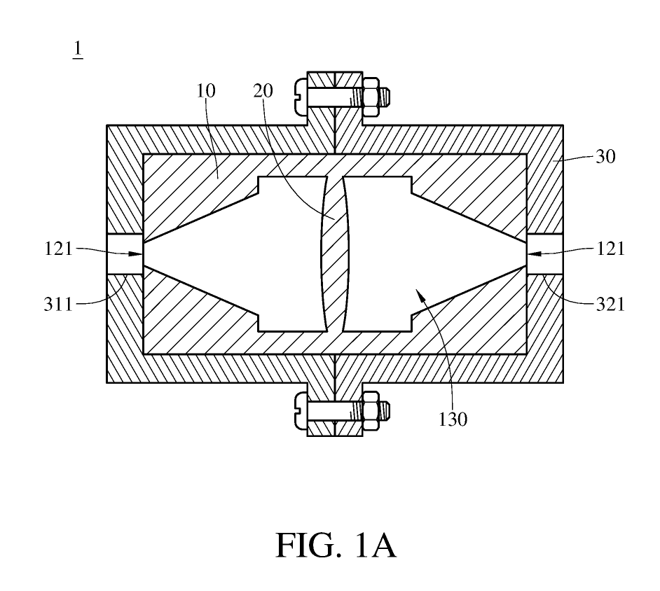

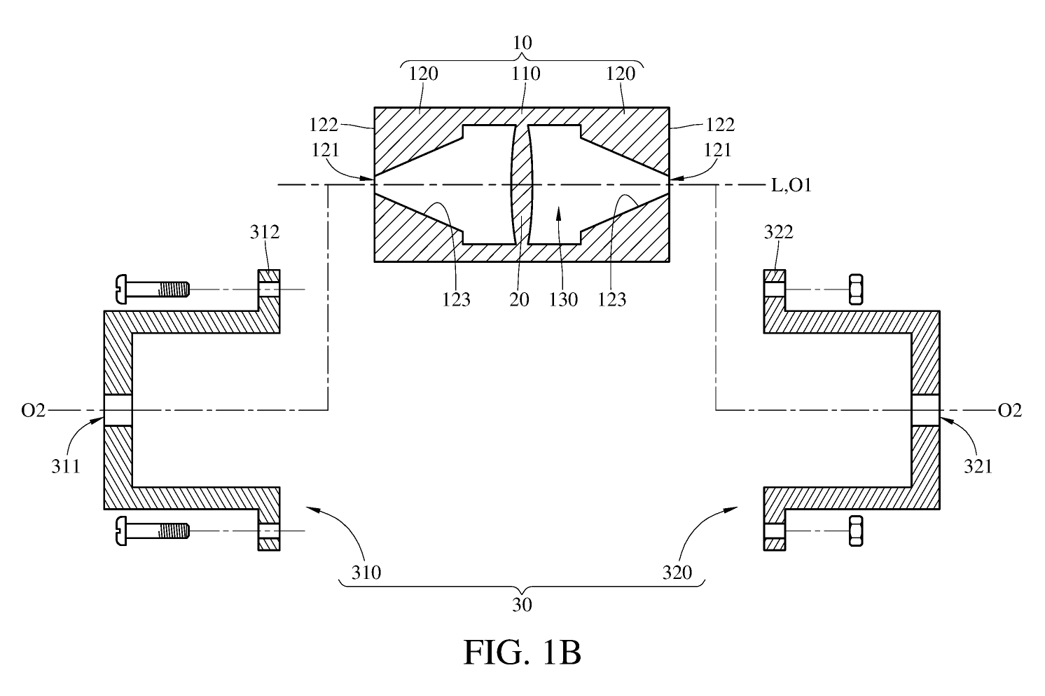

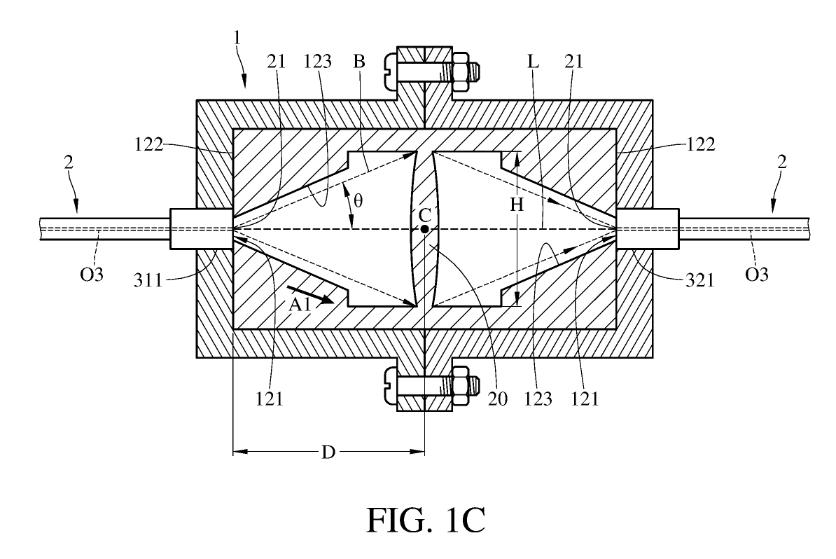

Please refer to FIG. 1A to FIG. 1C. FIG. 1A is a cross sectional view of a fiber optical coupler according to a first embodiment. FIG. 1B is an exploded view of the fiber optical coupler in FIG. 1A. FIG. 1C is a schematic view of two optical fibers coupled by the fiber optical coupler in FIG. 1A. In this embodiment, a fiber optical coupler 1 is provided. The fiber optical coupler 1 includes a base 10, a lens 20 and a casing 30.

The base 10 includes a middle portion 110 and two lateral portions 120. The two lateral portions 120 are respectively connected to two sides of the middle portion 110 opposite to each other. Each of the lateral portions 120 has a light passing opening 121, a blocking surface 122 and a cone-shaped inner surface 123. The light passing opening 121 is located on the blocking surface 122, and the light passing opening 121 is connected to the cone-shaped inner surface 123. The middle portion 110 and the two lateral portions 120 jointly form an accommodation chamber 130. The two light passing openings 121 are respectively connected to two sides of the accommodation chamber 130 opposite to each other, and the cone-shaped inner surfaces 123 form a part of the accommodation chamber 130. Referring to the lateral portions 120 of the base 10 shown in FIG. 1B, a cross sectional area of the cone-shaped inner surface 123 in the accommodation chamber 130 is gradually decreased along a direction from the lens 20 to one of the light passing openings 121. That is, an apex of the cone-shaped inner surface 123 is close to the blocking surface 122, and a base of the cone-shaped inner surface 123 is close to the middle portion 110, and the light passing opening 121 is connected to the apex of the cone-shaped inner surface 123.

The lens 20 is located in the accommodation chamber 130 and located between the two light passing openings 121. In detail, the lens 20 is fixed to the middle portion 110 of the base 10, and the lens 20 is disposed between the two cone-shaped inner surfaces 123. Each of the light passing openings 121 has a central axis O1, and the central axis O1 is overlapped with an optical axis L of the lens 20; that is, the lens 20 and the light passing openings 121 share the optical axis L (the optical axis L is referred as a common axis). In this embodiment, the base 10 and the lens 20 are integral with each other to form a mold casting made of transparent material, but the disclosure is not limited thereto. In some other embodiments, the base and the lens are two independent components, and the lens is assembled with the base to be located in the accommodation chamber.

Both the base 10 and the lens 20 are disposed in the casing 30. In detail, the casing 30 includes a first shell 310 and a second shell 320 connected to each other. The first shell 310 has a mounting hole 311 and a first fastening portion 312. The second shell 320 has a mounting hole 321 and a second fastening portion 322. Each of the mounting holes 311, 321 has a central axis O2, and the central axis O2 is substantially parallel to the optical axis L of the lens 20. The central axis O2 is overlapped with the optical axis L of the lens 20; that is, the mounting holes 311 and the lens 20 share the optical axis L. The first shell 310 is fixed to the second shell 320 by the first fastening portion 312 fixed to the second fastening portion 322. In detail, as shown in FIG. 1B, both the first fastening portion 312 and the second fastening portion 322 has a threaded hole (not numbered), and a screw is screwed into the threaded holes to fix the first fastening portion 312 and the second fastening portion 322 together. However, the disclosure is not limited thereto. In some other embodiments, either the first fastening portion or the second fastening portion has a recess, the other one has a protrusion matching the recess, and the first fastening portion is able to be directly fixed to the second fastening portion.

FIG. 1C shows a schematic view of using the fiber optical coupler 1 to couple two optical fibers 2. The two optical fibers 2 are respectively disposed on two sides of the lens 20 opposite to each other, and the two optical fibers 2 are respectively aligned with the two light passing openings 121. In detail, the two optical fibers 2 are respectively inserted into the mounting holes 311 and 321, and the two optical fibers 2 are respectively abutted against the two blocking surfaces 122. Each of the two optical fibers 2 has a core O3 overlapped with the optical axis L of the lens 20; that is, the two optical fibers 2 and the lens 20 share the optical axis L. The blocking surfaces 122 are favorable for positioning the optical fibers 2 relative to the lens 20 so as to prevent the coupling efficiency of the optical fiber 2 from decreasing due to the deviation of light path. As shown in FIG. 1C, one of the optical fibers 2 emits light from its light emitting end 21, thereby forming a cone B of light in the accommodation chamber 130 of the base 10. Light emitted by the optical fiber 2 enters into the lens 20 to be refracted, and then light exiting from the lens 20 is guided into the light emitting end 21 of the other optical fiber 2.

In this embodiment, in order to accomplish better coupling efficiency, a configuration of the fiber optical coupler 1 is determined as follows: when a numerical aperture of each of the optical fibers 2 is NA, an axial distance between the light emitting end 21 of each of the optical fibers 2 and the optical center C of the lens 20 is D, an effective radius of the lens 20 is H, a focal length of the lens 20 is f, half of a maximum angle of the cone B of light, that is able to enter or exit the lens 20, located between the optical fiber 2 and the lens 20 is θ, and the following conditions are satisfied:

θ=sin⁻¹(NA); (Condition 1)

and

D=2f=H/(2*tan θ). (Condition 2)

When Conditions 1 and 2 are satisfied simultaneously, a configuration of the fiber optical coupler 1 with high coupling efficiency is obtained. An exemplary design process is described hereafter. Firstly, the numerical aperture NA of the optical fiber 2 and the effective radius H of the lens 20 (usually, the effective radius H is the actual radius of the lens 20) are given. Then, the numerical aperture NA and the effective radius H are substituted in Condition 1 to obtain half of the maximum angle θ. Then, half of the maximum angle θ and the effective radius H are both substituted in Condition 2 to obtain the axial distance D. Finally, the size of the base 10 and the size of the casing 30 are determined according to the axial distance D. In this embodiment, a distance between each blocking surface 122 and the optical center C of the lens 20 is equal to the axial distance D, so that Condition 2 is satisfied when the optical fibers 2 are disposed on the fiber optical coupler 1.

In this embodiment, the axial distance between the light emitting end 21 of the optical fiber 2 and the optical center C of the lens 20 is equal to twice the focal length of the lens in Condition 2 (D=2f). When the light emitting end 21 is positioned on the optical axis L at a distance twice the focal length of the lens 20, it is favorable for maintaining the fiber optical coupler 1 in compact size as well as providing large depth of focus. Therefore, the optical fiber 2 and the blocking surface 122 have a wider assembly tolerance when the optical fiber 2 is inserted into the mounting hole 311 or 321, so that the coupling efficiency is prevented from overly low when the optical fiber 2 does not well touch the blocking surface 122.

Moreover, an angle between an extension direction A1 of the cone-shaped inner surface 123 and the optical axis L of the lens 20 is substantially equal to half of the maximum angle θ. That is, the shape of the cone-shaped inner surface 123 matches the shape of the cone B of light. Therefore, the light rays close to the edge of the cone B are prevented from diversion due to refraction at the cone-shaped inner surface 123, so that light emitted from one of the optical fibers 2 is able to be totally accepted by the other optical fiber 2, thereby preventing light loss while the optical fibers are in coupling. However, the present disclosure is not limited to the configuration of the cone-shaped inner surface 123. In some other embodiments, the angle between the extension direction of the cone-shaped inner surface and the optical axis of the lens is larger than half of the beam angle.

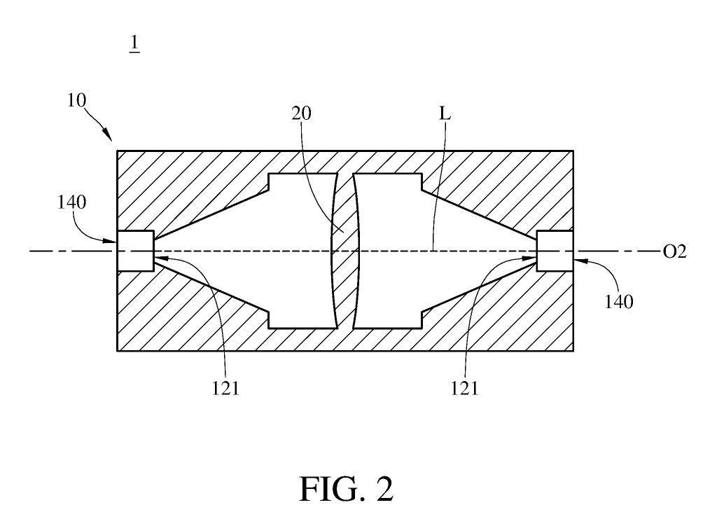

Although the fiber optical coupler includes the casing in the first embodiment, but the disclosure is not limited thereto. For example, please refer to FIG. 2, which is a cross sectional view of a fiber optical coupler according to a second embodiment. Since the second embodiment is similar to the first embodiment, only the differences are described hereafter.

In this embodiment, the fiber optical coupler 1 does not have any casing, and the base 10 has two mounting holes 140 which are respectively connected to the two light passing openings 121. Each of the two mounting holes 140 has a central axis O2 substantially parallel to the optical axis L of the lens 20, and the central axis O2 is overlapped with the optical axis L. Two optical fibers are configured to be respectively inserted into the two mounting holes 140 to be aligned with the two light passing openings 121. In this embodiment, the mounting holes are formed on the base 10, so that the casing is omitted. Therefore, it is favorable for the fiber optical coupler 1 in further compact size and reducing manufacturing cost.

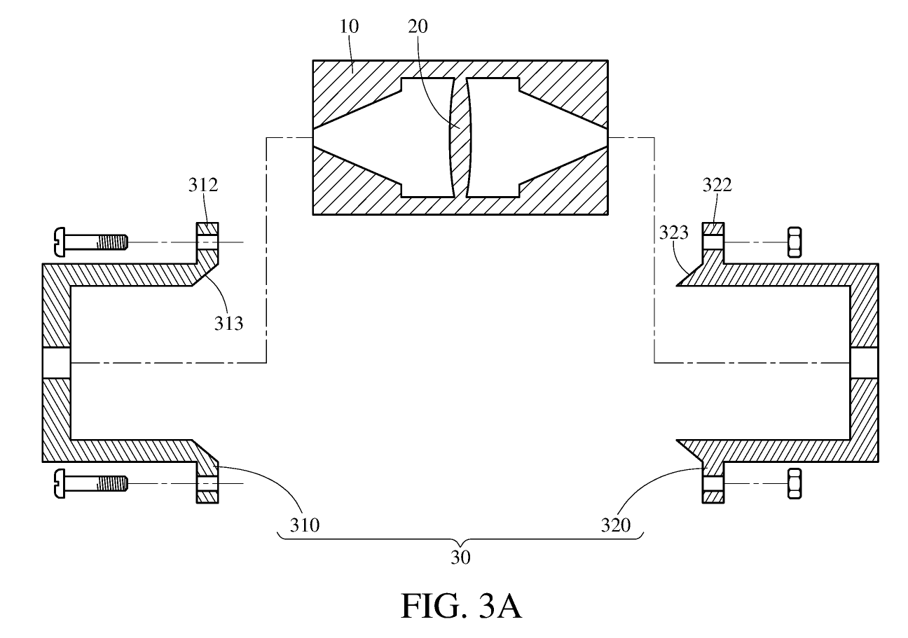

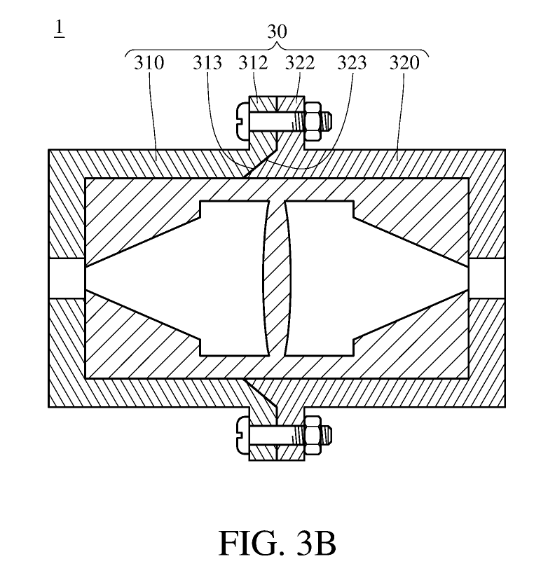

Then, the shells can include some auxiliary structures for assembly in order to improve coupling efficiency. For example, please refer to FIG. 3A and FIG. 3B, FIG. 3A is an exploded view of a fiber optical coupler according to a third embodiment. FIG. 3B is a cross sectional view of the fiber optical coupler in FIG. 3A. Since the third embodiment is similar to the first embodiment, only the differences are described hereafter.

In this embodiment, the first shell 310 of the casing 30 further has a first guiding slope 313, and the second shell 320 further has a second guiding slope 323 configured to be pressed against the first guiding slope 313. When the first shell 310 is fixed to the second shell 320 by the first fastening portion 312 and the second fastening portion 322, the first guiding slope 313 is slid on the second fastening portion 322 to assist the user to know when the first shell 310 and the second shell 320 are perfectly fixed together, thus it is favorable for reducing the deviation between the first shell 310 and the second shell 320 in the radial direction so as to prevent the coupling efficiency from overly low. However, the present disclosure is not limited to the guiding slopes to be taken as auxiliary structures for assembly. In some other embodiments, the shells of the fiber optical coupler respectively include a recess and a protrusion which are configured as auxiliary structures for assembly.

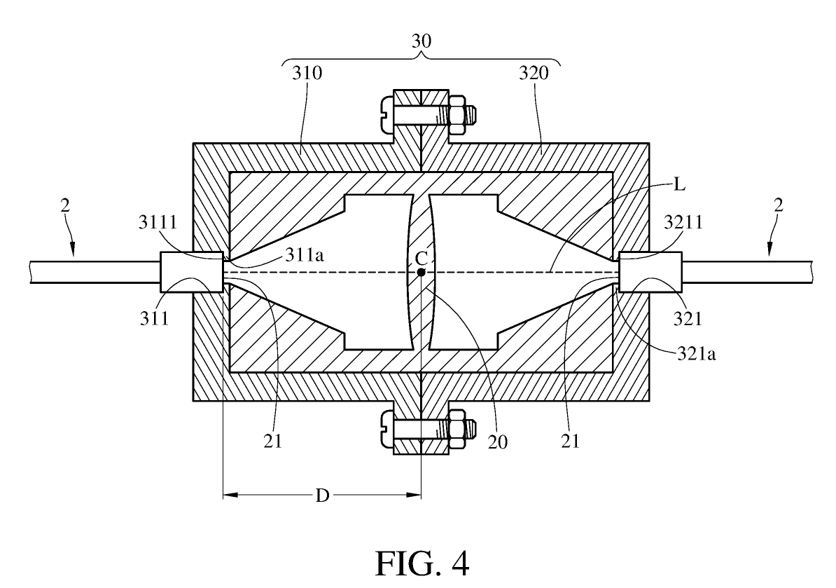

Then, please refer to FIG. 4. FIG. 4 is a cross sectional view of a fiber optical coupler according to a fourth embodiment while two optical fibers are coupled thereon. Since the fourth embodiment is similar to the first embodiment, only the differences will be described hereafter.

In this embodiment, the casing 30 includes two plates 311a and 321a which respectively protrude from the inner surface of the mounting holes 311 and 321, and the two plates 311a and 321a respectively have blocking surfaces 3111 and 3211. An axial distance between either the blocking surface 3111 or the blocking surface 3211 and the optical center C of the lens 20 is equal to the axial distance D between the light emitting end 21 of the optical fiber 2 and the optical center C of the lens 20.

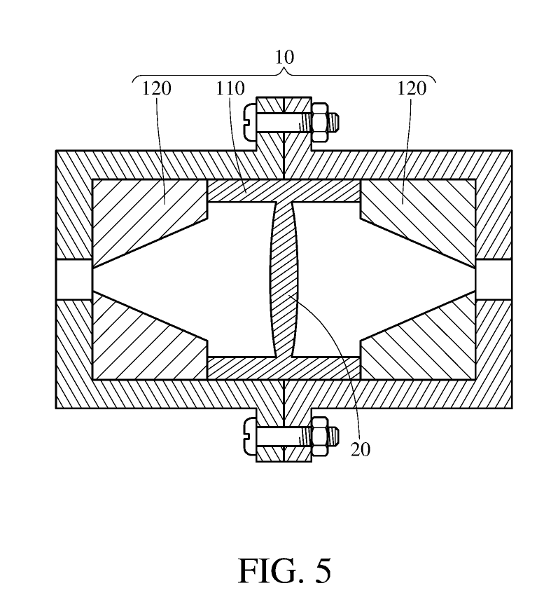

Then, please refer to FIG. 5. FIG. 5 is a cross sectional view of a fiber optical coupler according to a fifth embodiment. Since the fifth embodiment is similar to the first embodiment, only the differences are described hereafter.

In this embodiment, the middle portion 110 and middle portions 110 of the base 10 are three independent components. The lateral portions 120 are attached to two opposite sides of the middle portion 110, for example, by adhesion.

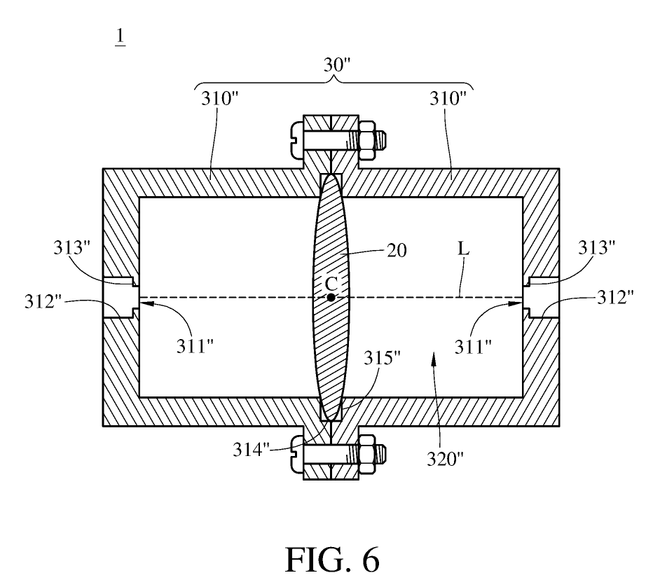

The fiber optical coupler includes the base in the aforementioned embodiments, and the lens is fixed to the base, but the disclosure is not limited thereto; instead, in some other embodiments, the fiber optical coupler may have no base. For example, please refer to FIG. 6. FIG. 6 is a cross sectional view of a fiber optical coupler according to a sixth embodiment. Since the sixth embodiment is similar to the first embodiment, only the differences will be described hereafter.

In this embodiment, the fiber optical coupler 1 includes the lens 20 and a casing 30″.

The casing 30″ includes two shells 310″ jointly forming an accommodation chamber 320″. Each of the two shells 310″ has a light passing opening 311″, a mounting hole 312″ and a blocking surface 313″. The two light passing openings 311″ are respectively connected to two opposite sides of the accommodation chamber 320″. The lens 20 is located in the accommodation chamber 320″ and disposed between the two light passing openings 311″. The two blocking surfaces 313″ respectively correspond to the two mounting hole 312″. A distance between each blocking surface 313″ and the optical center of the lens 20 is equal to the axial distance between the light emitting end of the optical fiber and the optical center C of the lens 20. Two optical fibers are configured to be respectively inserted into the two mounting holes 312″ to be aligned with the two light passing openings 311″.

Moreover, in this embodiment, the shells 310″ of the casing 30″ are assembled together to form a holding surface 314″, and one of the shells 310″ has a supporting surface 315″. An extension direction of the holding surface 314″ is substantially parallel to the optical axis L of the lens 20. The supporting surface 315″ is connected to the holding surface 314″, and the supporting surface 315″ extends toward the optical axis L of the lens 20. The lens 20 is pressed against the holding surface 314″ and leaned against the supporting surface 315″. Thus, the lens 20 is able to be put at a specific position in the casing 30″ without any base. Furthermore, the supporting surface 315″ is favorable for preventing the lens 20 from tilted, thus it is ensured that the optical axis L is parallel to the central axis of the light passing opening 311″ and the central axis of the mounting hole 312″ In this embodiment, both the holding surface 314″ and the supporting surface 315″ are annular to be fitted with the lens 20, so that the lens 20 is able to be securely held by the holding surface 314″ and abutted against the supporting surface 315″. However, any aforementioned description in the configuration of the holding surface 314″ and the supporting surface 315″ is not limited to the disclosure.

In this embodiment, the two shells 310″ are assembled together to form the holding surface 314″, but the disclosure is not limited thereto. In some other embodiments, the holding surface 314″ is formed on a single shell 310″.

Moreover, in this embodiment, the two shells 310″ of the casing 30″ each include a fastening portion as the fastening portions of the fiber optical coupler shown in FIG. 1A. In some other embodiments, the two shells 310″ each include a guiding slope as the guiding slopes of the fiber optical coupler shown in FIG. 3B. The detail description of the fastening portion and the guiding slope has been depicted in the aforementioned paragraphs, and is omitted hereafter.

According to the disclosure, the fiber optical coupler is able to couple two optical fibers. When a numerical aperture of each of the optical fibers is NA, an axial distance between the light emitting end of each of the optical fibers and the optical center of the lens is D, the effective radius of the lens is H, the focal length of the lens is f, half of the maximum angle of a cone of light located between one of the optical fibers and the lens is θ, and the following conditions are satisfied: θ=sin⁻¹(NA); and D=2f=H/(2*tan θ). Therefore, the fiber optical coupler is able to achieve high coupling efficiency by simple and low cost processes. In addition, since the optical fibers in the disclosure are not fused together, the optical fibers are easily detached from the fiber optical coupler, which is convenient to use.

Furthermore, when D=2f=H/(2*tan θ) is satisfied, the axial distance between the light emitting end of the optical fiber and the optical center of the lens is equal to twice the focal length of the lens. When the light emitting end is positioned on the optical axis at the distance twice the focal length of the lens, it is favorable for maintaining the fiber optical coupler in compact size as well as providing large depth of focus. Therefore, the optical fiber and the blocking surface have a wider assembly tolerance when the optical fiber is disposed on the fiber optical coupler, so that the coupling efficiency is prevented from overly low when the optical fiber is not well positioned at a predetermined position.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A fiber optical coupler configured to couple two optical fibers, the fiber optical coupler comprising:
a base having an accommodation chamber and two light passing openings, the two light passing openings respectively connected to two sides of the accommodation chamber opposite to each other; and
a lens disposed in the accommodation chamber and located between the two light passing openings, the two optical fibers configured to be respectively disposed on two sides of the lens opposite to each other and respectively aligned with the two light passing openings, and each of the two optical fibers having a core sharing an optical axis of the lens;
wherein a numerical aperture of each of the two optical fibers is NA, an axial distance between a light emitting end of each of the optical fibers and an optical center of the lens is D, an effective radius of the lens is H, a focal length of the lens is f, half of a maximum angle of a cone of light, that entering or exiting the lens, located between one of the optical fibers and the lens is θ, and the following conditions are satisfied:
θ=sin¹(NA); and
D=2f=H/(2*tan θ).

2. The fiber optical coupler according to claim 1, wherein the lens is fixed to the base, and the lens and each of the two light passing openings share the optical axis.

3. The fiber optical coupler according to claim 1, wherein the base further has two blocking surfaces, the two light passing openings are respectively located on the two blocking surfaces, a distance between each of the two blocking surfaces and the optical center of the lens is equal to the axial distance between the light emitting end of each of the optical fibers and the optical center of the lens, and the two optical fibers are configured to be respectively abutted against the two blocking surfaces.

4. The fiber optical coupler according to claim 1, wherein the lens is integral with the base.

5. The fiber optical coupler according to claim 1, wherein the base comprises a middle portion and two lateral portions, the two lateral portions are respectively located on two sides of the middle portion opposite to each other, the middle portion and the two lateral portions jointly form the accommodation chamber, the two lateral portions respectively have the two light passing openings, and the lens is fixed to the middle portion.

6. The fiber optical coupler according to claim 1, wherein the base further has two cone-shaped inner surfaces forming a part of the accommodation chamber, the two light passing openings are respectively connected to the two cone-shaped inner surfaces, the lens is disposed between the two cone-shaped inner surfaces, the two light passing openings are respectively located on two sides of the two cone-shaped inner surfaces, a cross sectional area of the cone-shaped inner surface in the accommodation chamber is gradually decreased along a direction from the lens to one of the light passing openings, an angle between an extension direction of one of the cone-shaped inner surfaces and the optical axis of the lens is substantially equal to half of the maximum angle of the cone of light.

7. The fiber optical coupler according to claim 1, wherein the base further has two mounting holes respectively connected to the two light passing openings, a central axis of each of the two mounting holes is substantially parallel to the optical axis of the lens, and the two optical fibers are configured to be respectively inserted into the two mounting holes to be aligned with the two light passing openings.

8. The fiber optical coupler according to claim 1, further comprising a casing, wherein the base is disposed in the casing, the casing has two mounting holes respectively connected to the two light passing openings, a central axis of each of the two mounting holes is substantially parallel to the optical axis of the lens, and the two optical fibers are configured to be respectively inserted into the two mounting holes to be aligned with the two light passing openings.

9. The fiber optical coupler according to claim 8, wherein the casing further has two blocking surfaces respectively corresponding to the two mounting holes, a distance between each of the two blocking surfaces and the optical center of the lens is equal to the axial distance between the light emitting end of each of the optical fibers and the optical center of the lens, and the two optical fibers are configured to be respectively abutted against the two blocking surfaces.

10. The fiber optical coupler according to claim 8, wherein the casing comprises a first shell and a second shell connected to each other, the first shell and the second shell respectively have the two mounting holes, the first shell further has at least one first fastening portion, the second shell further has at least one second fastening portion, and the first shell and the second shell are fixed together by the at least one first fastening portion and the at least one second fastening portion.

11. The fiber optical coupler according to claim 8, wherein the casing comprises a first shell and a second shell connected to each other, the first shell and the second shell respectively have the two mounting holes, the first shell further has a first guiding slope, and the second shell further has a second guiding slope touching the first guiding slope.

12. A fiber optical coupler configured to couple two optical fibers, the fiber optical coupler comprising:
a casing having an accommodation chamber and two light passing openings, the two light passing openings respectively connected to two sides of the accommodation chamber opposite to each other; and
a lens disposed in the accommodation chamber and located between the two light passing openings, the two optical fibers configured to be respectively disposed on two sides of the lens opposite to each other and respectively aligned with the two light passing openings, and each of the two optical fibers having a core sharing an optical axis of the lens;
wherein a numerical aperture of each of the two optical fibers is NA, an axial distance between a light emitting end of each of the optical fibers and an optical center of the lens is D, an effective radius of the lens is H, a focal length of the lens is f, half of a maximum angle of a cone of light, that entering or exiting the lens, located between one of the optical fibers and the lens is θ, and the following conditions are satisfied:
θ=sin⁻¹(NA); and
D=2f=H/(2*tan θ).

13. The fiber optical coupler according to claim 12, wherein the casing further has two blocking surfaces, the two light passing openings are respectively located on the two blocking surfaces, a distance between each of the two blocking surfaces and the optical center of the lens is equal to the axial distance between the light emitting end of each of the optical fibers and the optical center of the lens, and the two optical fibers are configured to be respectively abutted against the two blocking surfaces.

14. The fiber optical coupler according to claim 12, wherein the casing further has two mounting holes respectively connected to the two light passing openings, a central axis of each of the two mounting holes is substantially parallel to the optical axis of the lens, and the two optical fibers are configured to be respectively inserted into the two mounting holes to be aligned with the two light passing openings.

15. The fiber optical coupler according to claim 12, wherein the casing further has a holding surface forming a part of the accommodation chamber, an extension direction of the holding surface is substantially parallel to the optical axis of the lens, and the lens is pressed against the holding surface.

16. The fiber optical coupler according to claim 15, wherein the casing further has a supporting surface forming a part of the accommodation chamber, the supporting surface is connected to the holding surface, the supporting surface extends toward the optical axis of the lens, and the lens is leaned against the supporting surface.

17. The fiber optical coupler according to claim 12, wherein the casing comprises a first shell and a second shell connected to each other, the first shell and the second shell respectively have the two light passing openings, the first shell further has at least one first fastening portion, the second shell further has at least one second fastening portion, and the first shell and the second shell are fixed together by the at least one first fastening portion and the at least one second fastening portion.

18. The fiber optical coupler according to claim 12, wherein the casing comprises a first shell and a second shell connected to each other, the first shell and the second shell respectively have the two light passing openings, the first shell further has a first guiding slope, and the second shell further has a second guiding slope touching the first guiding slope.
